(19) United States
(12) Patent Application Publication
(10) Pub. No.: US 2009/0307503 A1
(43) Pub. Date: Dec. 10, 2009

(54) DIGITAL CONTENT MANAGEMENT SYSTEMS AND METHODS

(75) Inventors: Chi-Yang CHOU, Kao-hsiung (TW); Pei-Yen CHOU, Hsin-chu (TW); Yeu-Chung LIN, Chang-hua (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONDEL INTERNATIONAL TECHNOLOGIES INC., George Town (KY)

(21) Appl. No.: 12/136,128

(22) Filed: Jun. 10, 2008

(51) Int. Cl. H04L 9/06

(52) U.S. Cl. 713/193

(57) ABSTRACT

Digital content management systems and methods are provided for mass production of one or multiple digital contents. During the digital content management, the digital contents are first composed and encrypted to obtain encrypted digital contents. Then, the encrypted digital contents are copied and stored to at least one storage device. Finally, different identification data corresponding to the digital contents is respectively offered and stored to the at least one storage device. In this application, since the digital contents are first protected by encryption, and then copied to the storage device, the risk of the digital contents to be stolen or manipulated is reduced. Additionally, since the identification data are stored to the storage device in the last stage of the digital content management system, the efficiency of the mass production of the digital contents is improved.

### BACKGROUND OF THE INVENTION

1. Field of the Invention

The disclosure relates generally to digital content management, and, more particularly to systems and methods that enhance the digital rights management for digital content, and related production methods for digital content.

2. Description of the Related Art

With electronic devices, such as computers or portable devices, being popular, digital content has become a major data recording type for the devices due to increased convenience of digital content. Moreover, content providers have been devoted to develop related applications for digital content. Since it is easy to copy and broadcast digital content, the DRM (Digital Rights Management) and the mass production of preloading for digital content has become one of the major developmental areas in the digital content management art.

In a conventional digital rights management mechanism, digital content can be stored in a hidden area of a memory device, and an application can be stored in a public area of the memory device. Additionally, an activation key is produced for the memory device, and stored in the hidden area of the memory device. Since the digital content is in the hidden area, users will not have direct access of the digital content. The digital content in the hidden area must be accessed via the application using the activation key.

In another conventional digital content management system, a key and a serial code are preloaded in a hidden area of a medium, such as a VCD, DVD, or SD card; while digital content are DRM treated, such as encrypted, and stored in public area of storing medium. When an end device, such as an MP3/MP4 player, or PDA wants to access content in the medium, it is determined whether or not the serial code is legally authorized. If the serial code is legally authorized, the content is decrypted using the key, and then accessed. In this manner, the management system requires involvement and handshaking of the end device and the content provider as only authorized end device manufacturer has the access of the key and the serial code. Thus, the management system is unpractical as the benefits of the two parties might not be the same.

Based on the above digital rights management mechanism, the production method for digital content in the art is to first provide the digital content and the application to a software processing team. The software processing team bundles the digital content and the application, and respectively generates an activation key for each production copy of the digital content. Then, the digital contents, the applications, and the corresponding activation keys are provided to a manufacturer. The manufacturer correspondingly performs a preloading procedure for mass production of the digital content. During the preloading procedure, the digital contents in the respective memory devices are encrypted, and the corresponding activation keys are respectively stored to the respective memory devices.

It is understood that since related data (the digital content, the application, and the corresponding activation key) is not protected when it is provided to the manufacturer for the preloading procedure, the related data can be easily copied or stolen, resulting in a deficiency in the digital rights management. Additionally, since the activation keys for the respective preloading copies of the digital content are different, the preloading procedures for the respective preloading copies must be performed separately, thus reducing the efficiency of the preloading procedures.

### BRIEF SUMMARY OF THE INVENTION

Digital content management systems and methods are provided.

An embodiment of a digital content management system comprises a management unit and a preloading unit. The management unit composes and encrypts one or multiple digital contents to obtain encrypted digital contents. The preloading unit obtains the encrypted digital contents, and stores the encrypted digital contents to at least one storage device. After the preloading unit stores the encrypted digital contents to the at least one storage device, the management unit respectively stores different dedicated identification data representing the digital content to the at least one storage device.

In an embodiment of a digital content management method, one or multiple digital contents are first composed and encrypted to obtain encrypted digital contents. Then, the encrypted digital contents are copied and stored to at least one storage device. After the encrypted digital contents are stored to the at least one storage device, different dedicated identification data representing the digital content is respectively stored to the at least one storage device.

In an embodiment of a digital content management method, identification data in a storage device is authenticated via a network. When the authentication of the identification data passes, a decryption mechanism is activated to decrypt encrypted digital content in the storage device to obtain the complete digital content for access or use.

In an embodiment of a preloading production method for use in a content processing end and a preloading end for mass production of the at least one digital content, the content processing end composes and encrypts at least one digital content to obtain the encrypted digital content. The content processing end produces a mother disc using the encrypted digital content, and provides the mother disc to the preloading end. Then, the preloading end copies the content of the mother disc to one or multiple preloading devices. After the content of the mother disc is copied to the preloading device, the preloading end transmits the mother disc to the content processing end. The preloading end performs a preloading procedure via the preloading device according to the content of the mother disc, thus to copy the content of the mother disc to the at least one storage device. When the preloading procedure is completed, the preloading end removes the content of the mother disc from the preloading device, and transmits the storage device to the content processing end. Then, the content processing end respectively stores identification data to the storage device.

Digital content management methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a digital content management system according to the invention;

FIG. 2 is a flowchart of an embodiment of a digital content management method according to the invention;

FIG. 3 is a schematic diagram illustrating another embodiment of a digital content management system according to the invention;

FIG. 4 is a flowchart of another embodiment of a digital content management method according to the invention;

FIG. 5 is a schematic diagram illustrating further another embodiment of a digital content management system according to the invention; and

FIG. 6 is a flowchart of further another embodiment of a production method for preloading digital content according to the invention.

### DETAILED DESCRIPTION OF THE INVENTION

Digital content management systems and methods are provided.

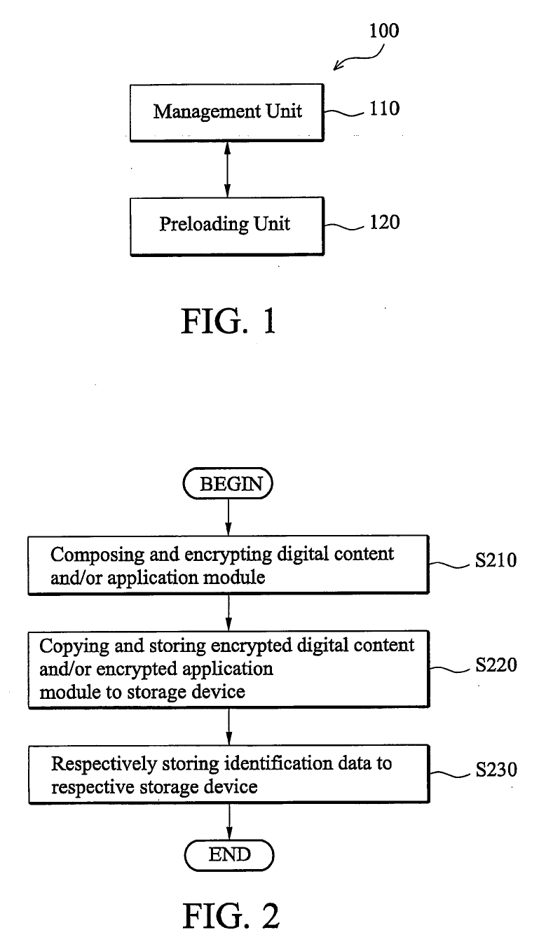

FIG. 1 is a schematic diagram illustrating an embodiment of a digital content management system according to the invention.

The digital content management system 100 comprises a management unit 110 and a preloading unit 120. The management unit 110 can compose and encrypt one or multiple digital contents (not shown) and/or an application module (not shown). It is noted that any encryption mechanism can be applied in the application. It is understood that, in some embodiments, the application module can be used to access or use the digital contents. The management unit 110 can generate different identification data for the respective copies of the digital contents. The preloading unit 120 can copy and store the digital contents to at least one storage device, such as a flash memory/card. It is understood that, in some embodiments, the management unit 110 and the preloading unit 120 can be located in an electronic device, such as a computer system. However, in some embodiments, the management unit 110 and the preloading unit 120 can be respectively located in different electronic devices.

FIG. 2 is a flowchart of an embodiment of a digital content management method according to the invention.

First, in step S210, the management unit 110 composes and encrypts one or multiple digital contents and/or an application module to obtain the encrypted digital contents and/or the encrypted application module. After the preloading unit 120 obtains the encrypted digital contents and/or the encrypted application module, in step S220, the preloading unit 120 copies and stores the encrypted digital contents and/or the encrypted application module to at least one storage device. Then, in step S230, the management unit 110 generates identification data for the respective copies of the digital contents, and respectively stores the identification data to the at least one storage device. It is noted that, in some embodiments, the management unit 110 can generate the identification data for the respective copies of the digital contents in advance. Additionally, in some embodiments, the management unit 110 respectively stores the identification data in a hidden area of the respective storage devices.

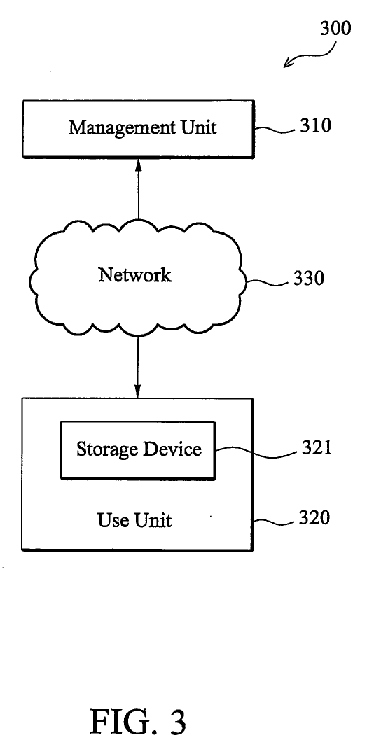

FIG. 3 is a schematic diagram illustrating another embodiment of a digital content management system according to the invention.

The digital content management system 300 comprises a management unit 310 and a use unit 320. The use unit 320 couples to the management unit 310 via a network 330, such as a LAN (Local Area Network), a WAN (Wide Area Network), an internet, a wireless network, and/or a telecommunication network. The use unit 320 comprises a storage device 321, such as a flash memory. The storage device 321 comprises identification data (not shown), a digital content in cipher (not shown), and/or an application module in cipher (not shown). In some embodiments, the use unit 320 may be an electronic device having identification data, such as a mobile phone. When the use unit 320 is a mobile phone, the identification data is the inner code of the mobile phone. The management unit 310 can receive the connection from the use unit 320 via the network 330, and perform the digital content management method of the application. Related details are discussed followed.

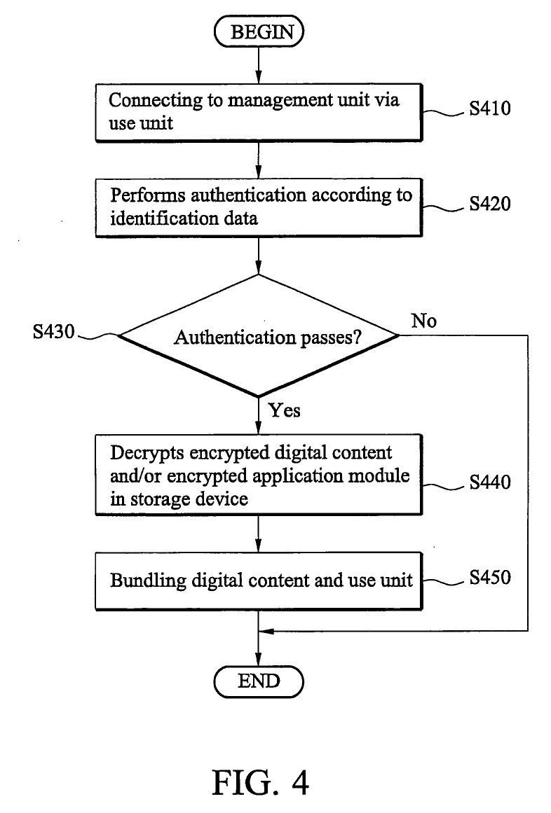

FIG. 4 is a flowchart of another embodiment of a digital content management method according to the invention.

In step S410, the use unit 320 couples to the management unit 310 via the network 330, and transmits the identification data stored in the storage device 321 to the management unit 310. In step S420, the management unit 310 performs an authentication according to the identification data. It is understood that, in some embodiments, the authentication is to determine whether or not the identification data is a correct identification data accepted by the management unit 310, and/or determine whether or not the identification data has been authenticated in the management unit 310. If the authentication for the identification data does not pass (No in step S430), the procedure is terminated. If the authentication for the identification data passes (Yes in step S430), in step S440, the management unit 310 decrypts the digital content in cipher and/or the application module in cipher in the storage device to obtain the digital content in plaintext and/or the application module in plaintext. It is understood that any decryption mechanism can be applied in the application. In step S450, the application module bundles the digital content and the use unit 320, such that the digital content can be only accessed or used in the use unit 320. It is understood that, in some embodiments, the method to bundle the digital content and the use unit 320 is to record the identification data of the use unit 320 in the application module. It is noted that, in some embodiments, the application module can be used to access or use the digital content. When a specific device comprising the storage device wants to access or use the digital content, the application module will first obtain the identification data of the specific device, and determine whether or not the identification data of the specific device conforms to the identification data recorded in the application module. When the identification data of the specific device conforms to the identification data preloaded in the application module, the digital content is accessed or used. When the identification data of the specific device does not conform to the identification data recorded in the application module, the digital content is not allowed to be accessed or used.

It is noted that, the embodiments in FIGS. 3 and 4 introduce the authentication of the storage device being performed via a network. It is understood that, any authentication manner can be applied to the storage devices produced according to the embodiments in FIGS. 1 and 2 of the application. For example, in some embodiments, the identification data in the storage device can be directly authenticated on the use unit 320, without the connection to the management unit 310 via the network.

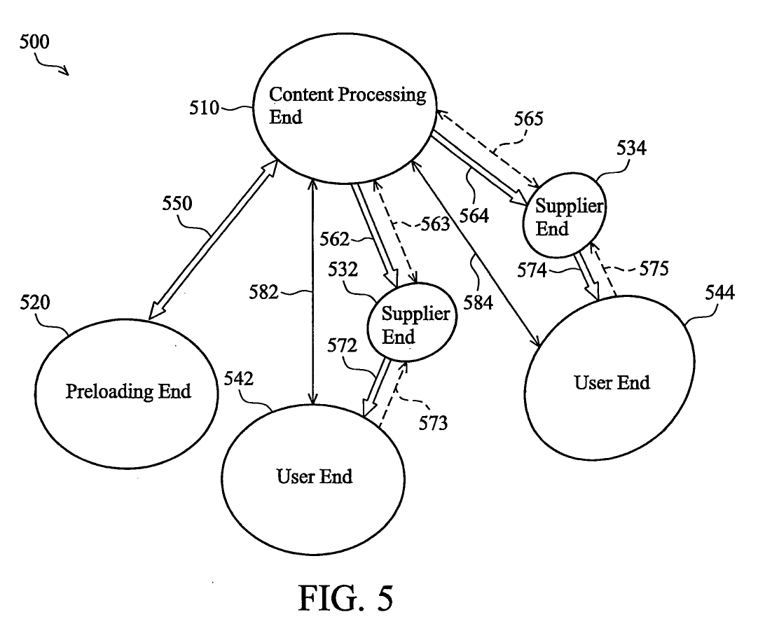

FIG. 5 is a schematic diagram illustrating further another embodiment of a digital content management system according to the invention. In this embodiment, the preloading, supply, and activation of digital content are disclosed.

As shown in FIG. 5, the digital content management system 500 comprises a content processing end 510, a preloading end 520, a plurality of supplier ends 532 and 534, and a plurality of user ends 542 and 544.

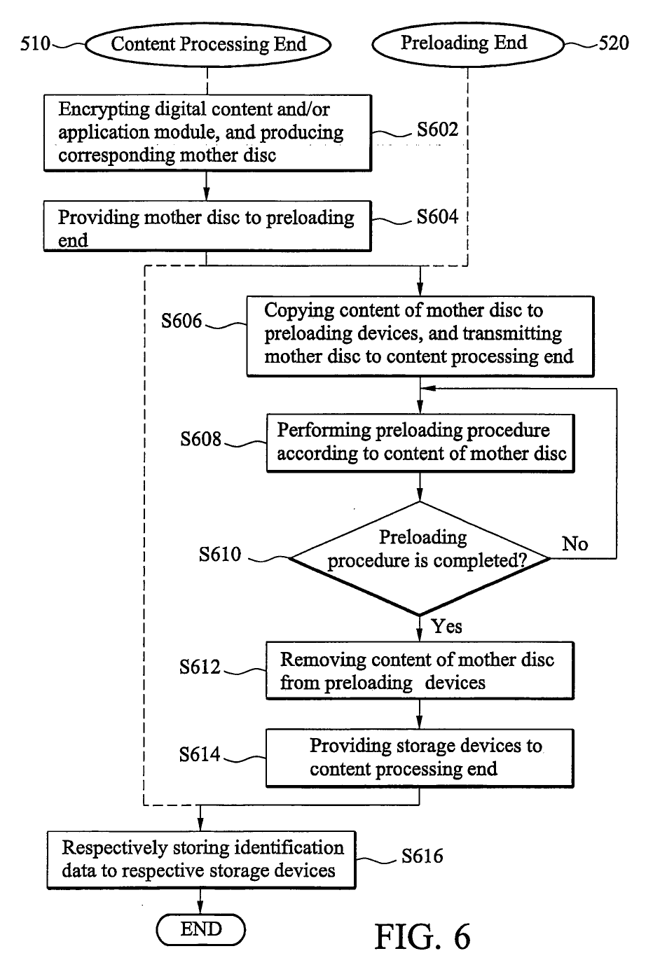

The content processing end 510 and the preloading 520 transmits a mother disc and storage devices via a material flow 550. FIG. 6 is a flowchart of further another embodiment of a production method for preloading digital content according to the invention. In step S602, the content processing end 510 encrypts a digital content and/or an application module, and produces a mother disc using the encrypted digital content and/or the encrypted application module. In step S604, the mother disc is transmitted to the preloading end 520. After receiving the mother disc, in step S606, the preloading end 520 copies the content of the mother disc to one or multiple preloading devices, such as copy devices. It is understood that, after the content of the mother disc is copied to the preloading device, the preloading end 520 transmits the mother disc to the content processing end 510. Then, in step S608, the preloading end 520 performs a preloading procedure using the preloading device according to the content of the mother disc, thus to copy the content of the mother disc to a number of storage devices, such as flash memories. In step S610, it is determined whether or not the preloading procedure is completed. If the preloading procedure is not completed (No in step S610), the procedure returns to step S608. If the preloading procedure is completed (Yes in step S610), in step S612, the content of the mother disc is removed (deleted) from the preloading devices, and in step S614, the storage devices with the content (the digital content and/or the application module) of the mother disc are transmitted to the content processing end 510. When the content processing end 510 receives the storage devices, in step S616, the content processing end 510 respectively stores different identification data to the storage devices. When the identification data is stored to a storage device, the preloading production for the digital content is completed. It is understood that, in the preloading procedure in the preloading end 520, the storage devices may be checked to determine whether or not the preloading procedure for the respective storage device is successful. If the preloading procedure for a storage device is not successful, the preloading procedure for the storage device can be repeated or the storage device can be scrapped.

After the storage devices having the identification data, the digital content and/or the application module are produced, the content processing end 510 can respectively deliver the storage devices to the supplier ends 532 and 534 via the material flows 562 and 564. User ends 542 and 544 can respectively obtain the storage devices from the supplier ends 532 and 534, thereby respectively generating the material flows 572 and 574 between the user ends 542 and 544 and the supplier ends 532 and 534. It is noted that, in some embodiments, the user ends must pay for the storage device, thereby respectively generating money flows 573 and 575 between the user ends 542 and 544 and the supplier ends 532 and 534. When the money flows 573 and 575 are generated, in some embodiments, the money flows 563 and 565 are also respectively generated between the content processing end 510 and the supplier ends 532 and 534 for related account management processes. After the user ends 542 and 544 respectively obtain the storage devices, connections to the content processing end 510 are respectively made using the corresponding electronic devices via information flows 582 and 584, for a subsequent authentication process for identification data of the storage devices, and decryption process for digital contents in the storage devices. It is understood that, the authentication process for identification data and the decryption process for digital contents are similar to the embodiment in FIG. 4, and is omitted here. When the authentication process for identification data and the decryption process for digital contents are completed, the user ends can respectively access or use the digital contents in the corresponding electronic devices.

Therefore, the digital content management systems and methods first encrypt the digital contents, and then perform the subsequent preloading procedure for mass production of the digital contents, thereby reducing the risk of the digital contents to be stolen or manipulated during the preloading procedure. Additionally, since the manufacture does not need to store activation keys (identification data) to the storage devices, the efficiency of the preloading procedure is improved.

Digital content management methods, or certain aspects or portions thereof, may take the form of a program code (i.e., executable instructions) embodied in tangible media, such as products flash card, USB disk, or any other machine-readable storage medium, wherein, when the program code is loaded into and executed by a machine, such as a computer, the machine thereby becomes an apparatus for practicing the methods.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A digital content management system, comprising:
a management unit composing and encrypting one or multiple digital contents to obtain the encrypted digital contents; and
a preloading obtaining the encrypted digital contents, and storing the encrypted digital contents to at least one storage device,
wherein after the preloading unit stores the encrypted digital contents to the storage device, the management unit stores identification data to the storage device.

2. The system of claim 1, further comprising a use unit coupled with the management unit via a network, wherein the use unit transmits the identification data in the storage device to the management unit.

3. The system of claim 2, wherein the management unit further performs an authentication for the identification data, and when the authentication passes, the management unit decrypts the encrypted digital contents in the storage device to obtain the digital contents in plaintexts.

4. The system of claim 3, wherein the management unit further encrypts an application module, and the preloading unit further stores the encrypted application module to the storage device, and when the authentication passes, the management unit further decrypts the encrypted application module in the storage device to obtain the application module in plaintext.

5. The system of claim 4, wherein the use unit accesses the digital contents via the application module.

6. The system of claim 4, wherein when the application module is decrypted, the application module bundles the digital contents and the use unit, such that the digital contents to only be accessed in the use unit.

7. The system of claim 6, wherein the application module records first identification data of the use unit, and before the digital contents are accessed in an electronic device, the application module obtains second identification data of the electronic device, determines whether the second identification data matches with the first identification data, and when the second identification data does not match with the first identification data, the digital contents are not allowed to be accessed.

8. The system of claim 7, wherein when the second identification data matches with the first identification data, the digital contents are accessed.

9. The system of claim 7, wherein the use unit comprises a mobile phone, and the first identification data is an inner code of the mobile phone.

10. The system of claim 1, wherein the storage device comprises a flash memory.

11. The system of claim 1, wherein the identification data is stored to a hidden area of the storage device.

12. A digital content management method, comprising:
composing and encrypting one or multiple digital contents to obtain the encrypted digital contents;
storing the encrypted digital contents to at least one storage device; and
after the encrypted digital contents are stored to the at least one storage device, respectively storing identification data to the at least one storage device.

13. The method of claim 12, further comprising performing an authentication for the identification data in the storage device via a network.

14. The method of claim 13, further comprising decrypting the encrypted digital contents in the storage device to obtain the digital contents in plaintexts when the authentication passes.

15. The method of claim 14, further comprising:
encrypting an application module;
storing the encrypted application module to the storage device; and
when the authentication passes, decrypting the encrypted application module in the storage device to obtain the application module in plaintext.

16. The method of claim 15, further accessing the digital contents via the application module.

17. The method of claim 15, further comprising the application module bundling the digital contents and a use unit, such that the digital contents to only be accessed in the use unit when the application module is decrypted.

18. The method of claim 17, wherein the application module records first identification data of the use unit, and the method comprises the steps of:
before the digital contents are accessed in an electronic device, the application module obtaining second identification data of the electronic device;
determining whether or not the second identification data matches with the first identification data; and
when the second identification data does not match with the first identification data, not allowing the digital contents to be accessed.

19. The method of claim 18, further comprising when the second identification data matches with the first identification data, allowing the digital contents to be accessed.

20. The method of claim 18, wherein the use unit comprises a mobile phone, and the first identification data is an inner code of the mobile phone.

21. The method of claim 12, wherein the storage device comprises a flash memory.

22. The method of claim 12, wherein the identification data is stored to a hidden area of the storage device.

23. A digital content management method, comprising:
authenticating identification data in a storage device via a network; and
when the authentication of the identification data passes, decrypting an encrypted digital content in the storage device to obtain the digital content in plaintexts.

24. The method of claim 23, wherein the storage device further comprise an encrypted application module, and the method further comprises a step of when the authentication for the identification data passes, decrypting the encrypted application module in the storage device to obtain the application module in plaintext.

25. The method of claim 24, further comprising accessed the digital content via the application module.

26. The method of claim 24, further comprising when the application module is obtained, the application module bundling the digital content and a use unit, enabling the digital content to only be accessed in the use unit.

27. A method for preloading a digital content for use in a content processing end and a preloading end, comprising:
the content processing end composing and encrypting the digital content to obtain the encrypted digital content;
the content processing end producing a mother disc using the encrypted digital content, and providing the mother disc to the preloading end;
the preloading end copying the content of the mother disc to at least one preloading device, and transmitting the mother disc to the content processing end after the content of the mother disc is copied to the preloading device;
the preloading end performing a preloading procedure via the preloading device according to the content of the mother disc, thus to copy the content of the mother disc to at least one storage device;
when the preloading procedure is completed, the preloading end removing the content of the mother disc from the preloading device;
the preloading end transmitting the storage device to the content processing end; and
the content processing end respectively storing identification data to the storage device.
